(19) United States
(12) Patent Application Publication
(10) Pub. No.: US 2019/0042965 A1
(43) Pub. Date: Feb. 7, 2019

(54) APPARATUS AND METHOD FOR A FIELD PROGRAMMABLE QUANTUM ARRAY

(71) Applicants: JAMES CLARKE, Portland, OR (US); SONIKA JOHRI, Portland, OR (US); ADAM HOLMES, Chicago, IL (US)

(72) Inventors: JAMES CLARKE, Portland, OR (US); SONIKA JOHRI, Portland, OR (US); ADAM HOLMES, Chicago, IL (US)

(21) Appl. No.: 15/942,300

(22) Filed: Mar. 30, 2018

(51) Int. Cl. G06N 99/00; G06F 8/41

(52) U.S. Cl. CPC G06N 99/002; G06F 8/447

(57) ABSTRACT

An apparatus and method are described for a field programmable quantum array. For example, one embodiment of an apparatus comprises: a quantum bit (qbit) lattice comprising a plurality of qbit locations; a quantum controller to execute quantum runtime code; a dynamic scheduler to analyze the quantum runtime code to detect quantum computational patterns within the quantum runtime code; an adaptive machine configuration controller to dynamically configure the qbit lattice based on the detected quantum computational patterns, the qbit lattice dynamically configured with some locations occupied by qbits and other locations not occupied by qbits; and the dynamic scheduler to modify at least a portion of the quantum runtime code based on the reconfiguration of the qbit lattice.

### BACKGROUND

### Field of the Invention

The embodiments of the invention relate generally to the field of quantum computing. More particularly, these embodiments relate to an apparatus and method for a field programmable quantum array.

### Description of the Related Art

Quantum computing refers to the field of research related to computation systems that use quantum mechanical phenomena to manipulate data. These quantum mechanical phenomena, such as superposition (in which a quantum variable can simultaneously exist in multiple different states) and entanglement (in which multiple quantum variables have related states irrespective of the distance between them in space or time), do not have analogs in the world of classical computing, and thus cannot be implemented with classical computing devices.

### BRIEF DESCRIPTION OF THE DRAWINGS

A better understanding of the present invention can be obtained from the following detailed description in conjunction with the following drawings, in which:

FIGS. 1A-1F illustrate various views of an example quantum dot device, in accordance with one embodiment;

FIG. 2 illustrates one embodiment of a quantum controller for analyzing a quantum runtime and responsively adjusting a quantum processor;

FIG. 3 illustrates an example qbit lattice with full occupancy;

FIG. 4 illustrates another example qbit lattice with a plurality of vacant locations not containing qbits; and

FIG. 5 illustrates a method in accordance with one embodiment of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Introduction

A quantum computer uses quantum-mechanical phenomena such as superposition and entanglement to perform computations. In contrast to digital computers which store data in one of two definite states (0 or 1), quantum computation uses quantum bits (qbits), which can be in superpositions of states. Qbits may be implemented using physically distinguishable quantum states of elementary particles such as electrons and photons. For example, the polarization of a photon may be used where the two states are vertical polarization and horizontal polarization. Similarly, the spin of an electron may have distinguishable states such as “up spin” and “down spin.”

Qbit states are typically represented by the bracket notations |0< and |1<. In a traditional computer system, a bit is exclusively in one state or the other, i.e., a ‘0’ or a ‘1.’ However, qbits in quantum mechanical systems can be in a superposition of both states at the same time, a trait that is unique and fundamental to quantum computing.

Quantum computing systems execute algorithms containing quantum logic operations performed on qubits. The sequence of operations is statically compiled into a schedule and the qubits are addressed using an indexing scheme. This algorithm is then executed a sufficiently large number of times until the confidence interval of the computed answer is above a threshold (e.g., ˜95+%). Hitting the threshold means that the desired algorithmic result has been reached.

Qbits have been implemented using a variety of different technologies which are capable of manipulating and reading quantum states. These include, but are not limited to quantum dot devices (spin based and spatial based), trapped-ion devices, superconducting quantum computers, optical lattices, nuclear magnetic resonance computers, solid-state NMR Kane quantum devices, electrons-on-helium quantum computers, cavity quantum electrodynamics (CQED) devices, molecular magnet computers, and fullerene-based ESR quantum computers, to name a few. While a quantum dot device is described below in relation to certain embodiments of the invention, the underlying principles of the invention may be employed in combination with any type of quantum processor including, but not limited to, those listed above. The particular physical qbit implementation is orthogonal to the embodiments of the invention described herein.

### Quantum Dot Devices

Quantum dots are small semiconductor particles, typically a few nanometers in size. Because of this small size, quantum dots operate according to the rules of quantum mechanics, having optical and electronic properties which differ from macroscopic entities. Quantum dots are sometimes referred to as “artificial atoms” to connote the fact that a quantum dot is a single object with discrete, bound electronic states, as is the case with atoms or molecules.

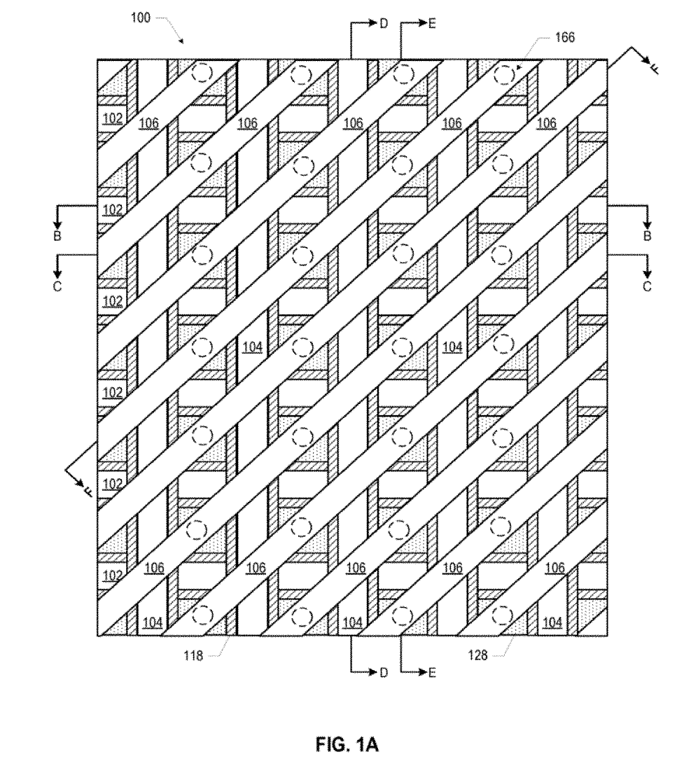

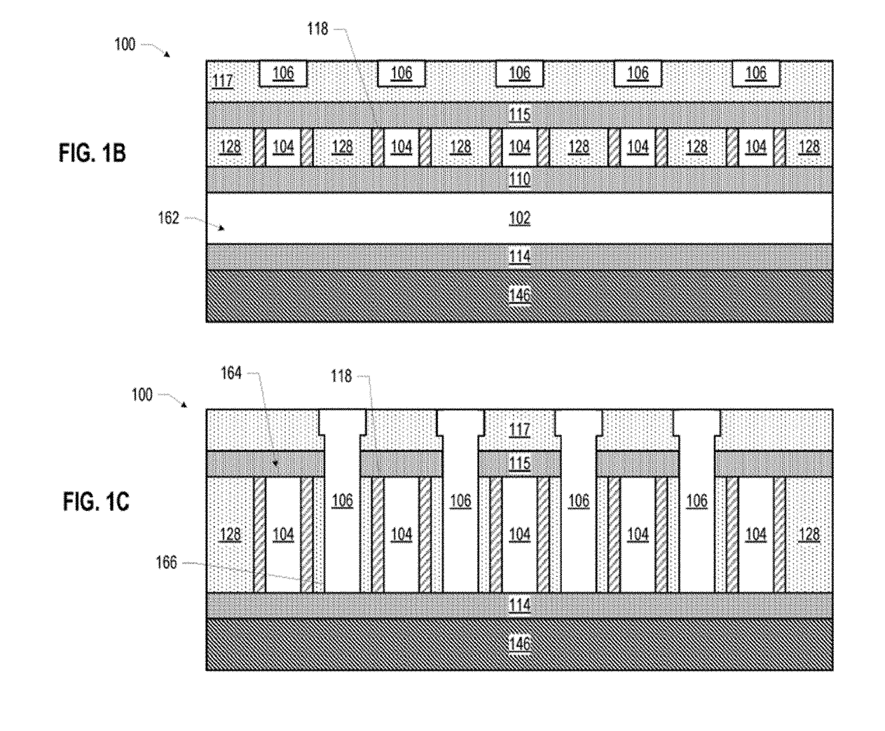

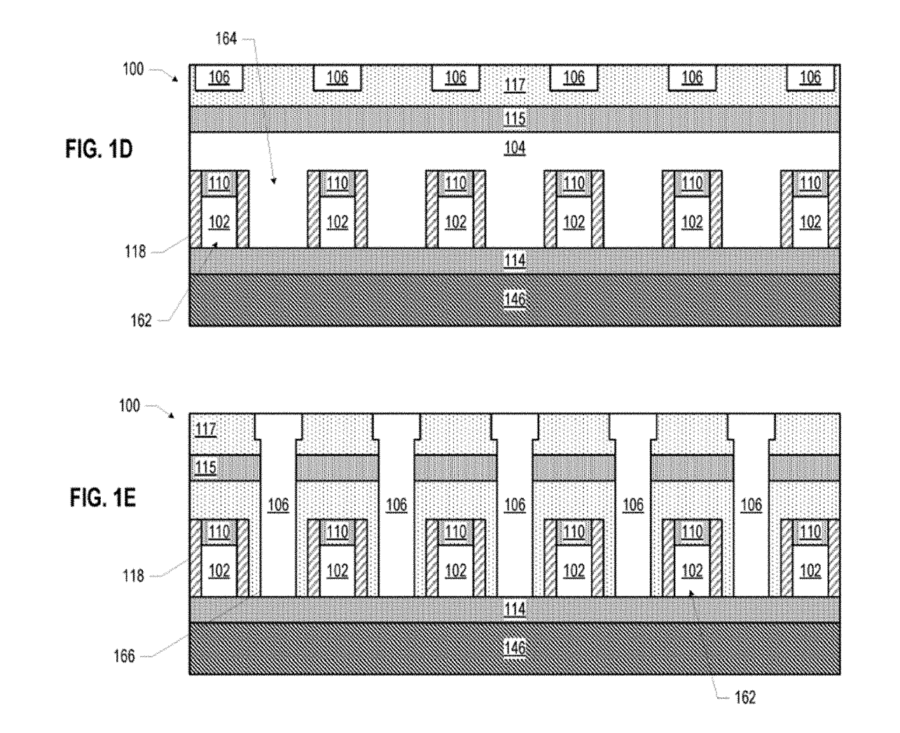

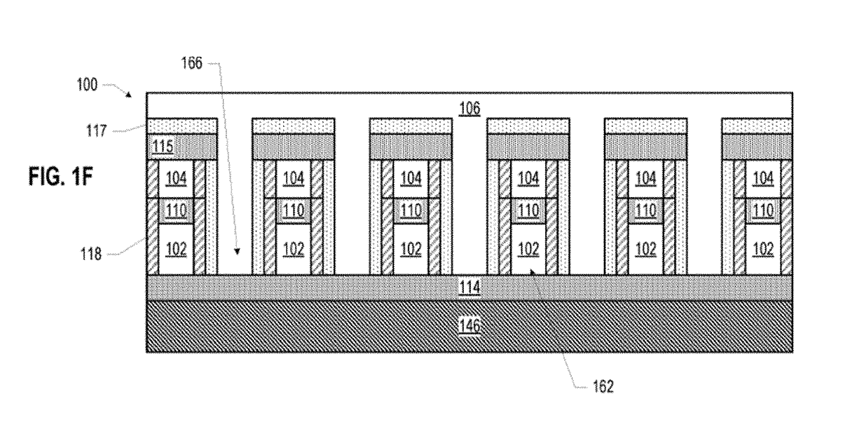

FIGS. 1A-1F are various views of a quantum dot device 100, which may be used with embodiments of the invention described below. FIG. 1A is a top view of a portion of the quantum dot device 100 with some of the materials removed so that the first gate lines 102, the second gate lines 104, and the third gate lines 106 are visible. Although many of the drawings and description herein may refer to a particular set of lines or gates as “barrier” or “quantum dot” lines or gates, respectively, this is simply for ease of discussion, and in other embodiments, the role of “barrier” and “quantum dot” lines and gates may be switched (e.g., barrier gates may instead act as quantum dot gates, and vice versa). FIGS. 1B-1F are side cross-sectional views of the quantum dot device 100 of FIG. 1A; in particular, FIG. 1B is a view through the section B-B of FIG. 1A, FIG. 1C is a view through the section C-C of FIG. 1A, FIG. 1D is a view through the section D-D of FIG. 1A, FIG. 1E is a view through the section E-E of FIG. 1A, and FIG. 1F is a view through the section F-F of FIG. 1A.

The quantum dot device 100 of FIG. 1 may be operated in any of a number of ways. For example, in some embodiments, electrical signals such as voltages, currents, radio frequency (RF), and/or microwave signals, may be provided to one or more first gate line 102, second gate line 104, and/or third gate line 106 to cause a quantum dot (e.g., an electron spin-based quantum dot or a hole spin-based quantum dot) to form in a quantum well stack 146 under a third gate 166 of a third gate line 106. Electrical signals provided to a third gate line 106 may control the electrical potential of a quantum well under the third gates 166 of that third gate line 106, while electrical signals provided to a first gate line 102 (and/or a second gate line 104) may control the potential energy barrier under the first gates 162 of that first gate line 102 (and/or the second gates 164 of that second gate line 104) between adjacent quantum wells. Quantum interactions between quantum dots in different quantum wells in the quantum well stack 146 (e.g., under different quantum dot gates) may be controlled in part by the potential energy barrier provided by the barrier potentials imposed between them (e.g., by intervening barrier gates).

Generally, the quantum dot devices 100 disclosed herein may further include a source of magnetic fields (not shown) that may be used to create an energy difference in the states of a quantum dot (e.g., the spin states of an electron spin-based quantum dot) that are normally degenerate, and the states of the quantum dots (e.g., the spin states) may be manipulated by applying electromagnetic energy to the gates lines to create quantum bits capable of computation. The source of magnetic fields may be one or more magnet lines, as discussed below. Thus, the quantum dot devices 100 disclosed herein may, through controlled application of electromagnetic energy, be able to manipulate the position, number, and quantum state (e.g., spin) of quantum dots in the quantum well stack 146.

In the quantum dot device 100 of FIG. 1, a gate dielectric 114 may be disposed on a quantum well stack 146. A quantum well stack 146 may include at least one quantum well layer 152 (not shown in FIG. 1) in which quantum dots may be localized during operation of the quantum dot device 100. The gate dielectric 114 may be any suitable material, such as a high-k material. Multiple parallel first gate lines 102 may be disposed on the gate dielectric 114, and spacer material 118 may be disposed on side faces of the first gate lines 102. In some embodiments, a patterned hardmask 110 may be disposed on the first gate lines 102 (with the pattern corresponding to the pattern of the first gate lines 102), and the spacer material 118 may extend up the sides of the hardmask 110, as shown. The first gate lines 102 may each be a first gate 162. Different ones of the first gate lines 102 may be electrically controlled in any desired combination (e.g., each first gate line 102 may be separately electrically controlled, or some or all the first gate lines 102 may be shorted together in one or more groups, as desired).

Multiple parallel second gate lines 104 may be disposed over and between the first gate lines 102. As illustrated in FIG. 1, the second gate lines 104 may be arranged perpendicular to the first gate lines 102. The second gate lines 104 may extend over the hardmask 110, and may include second gates 164 that extend down toward the quantum well stack 146 and contact the gate dielectric 114 between adjacent ones of the first gate lines 102, as illustrated in FIG. 1D. In some embodiments, the second gates 164 may fill the area between adjacent ones of the first gate lines 102/spacer material 118 structures; in other embodiments, an insulating material (not shown) may be present between the first gate lines 102/spacer material 118 structures and the proximate second gates 164. In some embodiments, spacer material 118 may be disposed on side faces of the second gate lines 104; in other embodiments, no spacer material 118 may be disposed on side faces of the second gate lines 104. In some embodiments, a hardmask 115 may be disposed above the second gate lines 104. Multiple ones of the second gates 164 of a second gate line 104 are electrically continuous (due to the shared conductive material of the second gate line 104 over the hardmask 110). Different ones of the second gate lines 104 may be electrically controlled in any desired combination (e.g., each second gate line 104 may be separately electrically controlled, or some or all the second gate lines 104 may be shorted together in one or more groups, as desired). Together, the first gate lines 102 and the second gate lines 104 may form a grid, as depicted in FIG. 1.

Multiple parallel third gate lines 106 may be disposed over and between the first gate lines 102 and the second gate lines 104. As illustrated in FIG. 1, the third gate lines 106 may be arranged diagonal to the first gate lines 102, and diagonal to the second gate lines 104. In particular, the third gate lines 106 may be arranged diagonally over the openings in the grid formed by the first gate lines 102 and the second gate lines 104. The third gate lines 106 may include third gates 166 that extend down to the gate dielectric 114 in the openings in the grid formed by the first gate lines 102 and the second gate lines 104; thus, each third gate 166 may be bordered by two different first gate lines 102 and two different second gate lines 104. In some embodiments, the third gates 166 may be bordered by insulating material 128; in other embodiments, the third gates 166 may fill the openings in the grid (e.g., contacting the spacer material 118 disposed on side faces of the adjacent first gate lines 102 and the second gate lines 104, not shown). Additional insulating material 117 may be disposed on and/or around the third gate lines 106. Multiple ones of the third gates 166 of a third gate line 106 are electrically continuous (due to the shared conductive material of the third gate line 106 over the first gate lines 102 and the second gate lines 104). Different ones of the third gate lines 106 may be electrically controlled in any desired combination (e.g., each third gate line 106 may be separately electrically controlled, or some or all the third gate lines 106 may be shorted together in one or more groups, as desired).

Although FIGS. 1A-F illustrate a particular number of first gate lines 102, second gate lines 104, and third gate lines 106, this is simply for illustrative purposes, and any number of first gate lines 102, second gate lines 104, and third gate lines 106 may be included in a quantum dot device 100. Other examples of arrangements of first gate lines 102, second gate lines 104, and third gate lines 106 are possible. Electrical interconnects (e.g., vias and conductive lines) may contact the first gate lines 102, second gate lines 104, and third gate lines 106 in any desired manner.

Not illustrated in FIG. 1, are accumulation regions that may be electrically coupled to the quantum well layer of the quantum well stack 146 (e.g., laterally proximate to the quantum well layer). The accumulation regions may be spaced apart from the gate lines by a thin layer of an intervening dielectric material. The accumulation regions may be regions in which carriers accumulate (e.g., due to doping, or due to the presence of large electrodes that pull carriers into the quantum well layer), and may serve as reservoirs of carriers that can be selectively drawn into the areas of the quantum well layer under the third gates 166 (e.g., by controlling the voltages on the quantum dot gates, the first gates 162, and the second gates 164) to form carrier-based quantum dots (e.g., electron or hole quantum dots, including a single charge carrier, multiple charge carriers, or no charge carriers). In other embodiments, a quantum dot device 100 may not include lateral accumulation regions, but may instead include doped layers within the quantum well stack 146. These doped layers may provide the carriers to the quantum well layer. Any combination of accumulation regions (e.g., doped or non-doped) or doped layers in a quantum well stack 146 may be used in any of the embodiments of the quantum dot devices 100 disclosed herein.

### Apparatus and Method For a Field Programmable Quantum Array

Quantum algorithms often require compilation into multi-qubit gates which are performed between qubits which are physically interconnected on a qubit plane (e.g., such as the quantum dot device described above). In a quantum system in which shuttling physical qubits between dot sites is faster and more robust than performing two qubit swap gates, there is an optimization tradeoff between introducing sparsity into a qubit lattice to increase the effective connectivity of the physical device, at the expense of losing computational elements. Different quantum workloads may present a wide range of computational patterns, which may execute optimally on machines with different levels and types of physical connectivity. In one embodiment of the invention, in response to these types of computational patterns, quantum processors are selectively reconfigured to vacate or fill quantum dot sites in order to raise or lower the local connectivity in certain regions.

In existing quantum processors, scheduling and mapping operations do not consider devices with reconfigurable topologies. Instead, devices are assumed to be statically configured and schedules are designed with this assumption. Adaptive techniques in quantum computing are now being researched for some control methods, but not based on reconfiguring physical device connectivity or topology.

Quantum algorithms consist of quantum logic operations performed on qubits. The sequence of operations is statically compiled into a schedule appropriate for a specific physical quantum processor's description with respect to qubit connectivity and control constraints (i.e., a specific number of qbits and control lines having a specified physical arrangement within the quantum processor). L For certain algorithms, quantum dot devices offer a regime where shuttling individual qubits between dot sites may be both faster and more robust than performing multi-qubit gate operations.

One embodiment of the invention includes a dynamic scheduler which reconfigures the occupation of quantum dot sites in a physical quantum machine in response to specific computational sequences. In particular, one embodiment of the dynamic scheduler analyzes the logical program specifications and identifies computational patterns presented within those specifications. For example, the dynamic scheduler may detect computational hot and cold zones and characterize them as such. Using the data identified by the dynamic scheduler, an adaptive machine configuration controller chooses occupation densities on the physical quantum processor (e.g., shuttling electrons between quantum dot sites). The dynamic scheduler then adjusts the physical machine schedule to accommodate the new machine configuration.

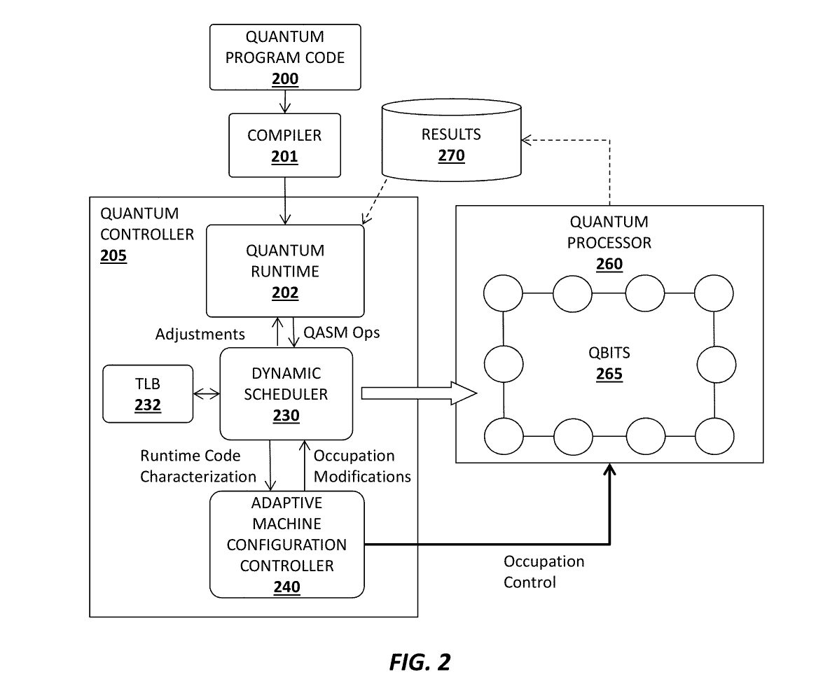

FIG. 2 illustrates one embodiment of a quantum computing architecture which includes a quantum processor 260 comprising a plurality of qbits 265 which are manipulated in response to signals from a quantum controller 205. The signals may include, for example, electrical or electromagnetic signals which adjust potentials in specific regions of a quantum dot device to move electrons between quantum dot locations.

In one embodiment, the quantum controller 205 executes a quantum runtime 202 to perform a sequence of operations on the quantum processor 260. For example, at least a portion of the quantum controller 205 may include a memory for storing the quantum runtime 201 and a processor for processing the quantum runtime. In one embodiment, the programmer writes quantum program code 200 (i.e., source code) which is translated into the quantum runtime 202 by a compiler 201.

The quantum controller 205 may include both a general purpose processor to execute software (e.g., the quantum runtime 202) and specialized circuitry including electromagnetic transceivers and voltage control circuits to control the qbits. In one embodiment, in response to execution of the quantum runtime code 201, the quantum processor 260 performs operations on the qbits 265 to generate results 270. In one implementation, multiple iterations of a particular operation or a series of operations are required to generate the final results 270.

A dynamic scheduler 230 schedules operations to be performed on the quantum processor 260 as specified by the quantum runtime 202. As mentioned, in one embodiment, the dynamic scheduler 230 analyzes the logical program specifications of the quantum runtime 202 and identifies computational patterns presented within those specifications. For example, the dynamic scheduler 230 may detect computational hot and cold zones over time and characterize them to the adaptive machine configuration controller 240.

Using the data identified by the dynamic scheduler, the adaptive machine configuration controller 240 chooses and configures occupation densities on the physical quantum processor 260. In one implementation, this involves a sequence of shuttling operations to move electrons to different vacant quantum dot locations (potentially moving through multiple vacant locations before arriving at the desired location). As discussed above, moving a qbit between quantum dots may be accomplished using electrical signals provided gate lines to control the potential energy barrier between adjacent quantum wells. Moreover, once the qbits have been set at the desired locations, quantum interactions between qbits in different quantum wells may be controlled at least in part by the barrier potentials imposed between them (e.g., by intervening barrier gates).

Once the adaptive machine configuration controller 240 has successfully configured the qbits at particular locations within the quantum processor (and with a selected density/sparsity), the dynamic scheduler 230 then adjusts the physical quantum processor 260 schedule in view of the occupation modifications performed by the adaptive machine configuration controller 240. For example, if the adaptive machine configuration controller 240 has configured a sparse quantum processor with numerous vacant locations, the dynamic scheduler may change certain swap gate operations to shuttle operations (e.g., where a qbit is adjacent to a vacant location rather than an occupied location).

Although not illustrated in FIG. 2, one or more physical layer devices perform the underlying operations on the qbits 265 as specified by the adaptive machine configuration controller 240 and dynamic scheduler 230. For example, the physical layer devices may include precisely targeted and calibrated electromagnetic transmitters to generate microwaves or other electromagnetic waves to manipulate the qbits 265 and may also include precise voltage regulation devices to raise and lower barrier potentials between quantum wells.

In one embodiment, the results 270 of the qbit operations are stored in a database, file system, or other form of data storage structure. While illustrated separately from the quantum runtime 202 and quantum controller 205, the results 270, quantum controller 205 and quantum runtime 202 may all be implemented on the same physical computing device such as a server or workstation with a memory, at least one processor, a storage device and a serial and/or wireless communication interfaces to couple the quantum controller 205 to a network.

As indicated in FIG. 2, one embodiment of the quantum runtime 202 transmits operations to the quantum controller 205 in accordance with the Open Quantum Assembly Language (QASM), an intermediate representation for quantum instructions. However, the underlying principles of the invention are not limited to any particular language.

In one embodiment, the dynamic scheduler 230 is coupled to (or includes) a translation lookaside buffer (TLB) 232 to translate virtual qbit addresses to physical qbit addresses to physically access the qbits 265. In one implementation, the dynamic scheduler 230 changes physical qubit addressing within the TLB 232 in accordance with the configuration changes made by the adaptive machine configuration controller 240. For example, the dynamic scheduler 230 may associate new physical addresses to virtual addresses for a new set of qbit locations within the quantum processor 260 in response to the changes made by the adaptive machine configuration controller 240.

Quantum applications are characterized by a diverse range of computational patterns, yet physical quantum machines are today designed to be fabricated a single time and statically maintained. Selectively choosing occupation densities for areas of a 2-Dimensional qubit lattice enables devices to change their effective local connectivity, allowing them to take advantage of computational pattern differences among quantum applications.

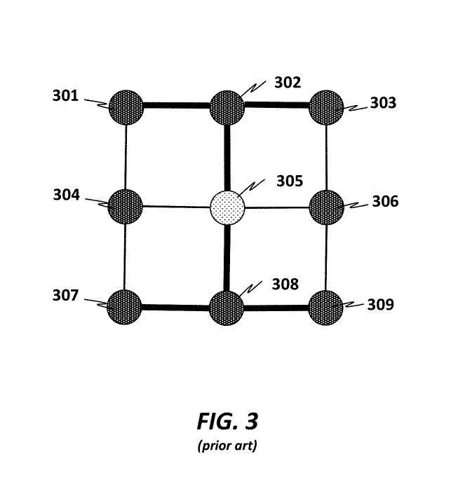

FIG. 3 illustrates an example of a qubit lattice comprising nine interconnected qbits 301-309. In this example, a qbit is positioned at each site of the lattice (i.e., the occupational density is 100%). As such, in order to move qbit 305 from its current location to another location in the lattice, such as the location of qbit 303, the controller must perform one or more “swap” operations sometimes referred to as “two qbit gates” or “swap gates.” For example, to allow qbit 305 to interact with qbit 303 (e.g., to entangle the qbits), a swap gate operation must first be performed between qbit 305 and qbit 302 (or 306) so that qbit 305 is adjacent to qbit 303. Following the swap gate operation, qbits 302 and 305 will have switched locations.

While swap gate operations may be the most efficient way to proceed for some algorithms, they produce additional noise and can be problematic on certain quantum processors. Moreover, other algorithms will run significantly more efficiently using shuttling operations in which the qbits are moved through vacant locations in a lattice to reach a destination. When moving a physical qubit through a lattice is faster and more robust than performing two qubit gates, then the existence of shuttling pathways allows for physically separated qubits to interact quickly, effectively increasing device connectivity. The lattice shown in FIG. 3 is incapable of shuttling, however, because each location is occupied.

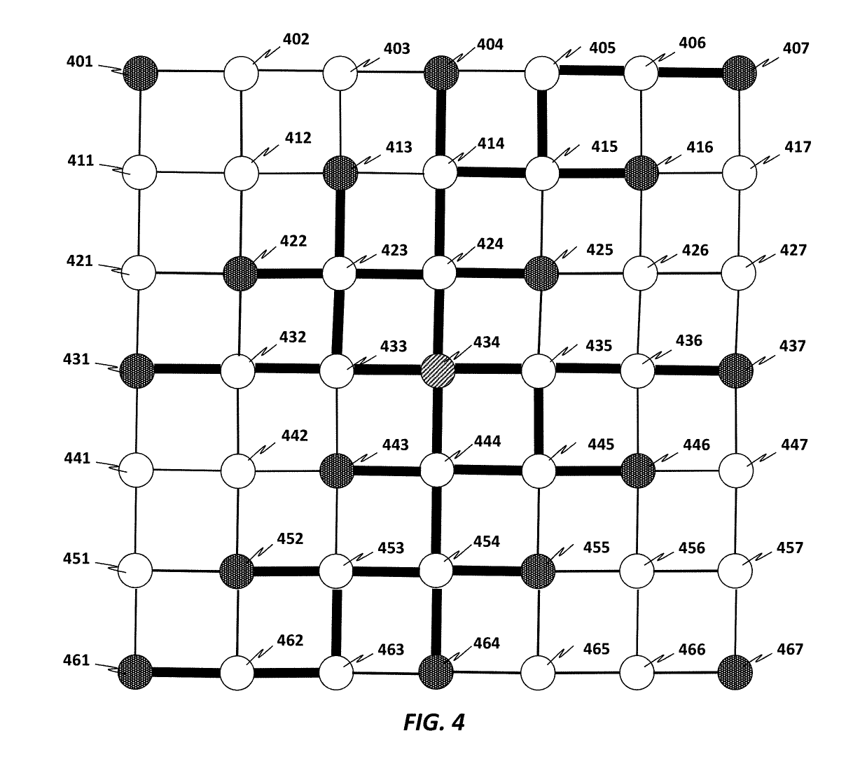

In contrast, FIG. 4 illustrates one embodiment of a qbit lattice 400 in which only ⅓ of the 49 locations 401-407, 411-417, 421-427, 431-437, 441-447, 451-457, 461-467, 411-417 contain qbits (i.e., it has ⅓ occupation). In this example, darkly-colored circles 401, 404, 407, 413, 416, 422, 425, 431, 434, 437, 443, 446, 452, 455, 461, 464, and 467 are quantum dots which contain qbits while the remaining unmarked locations are vacant. Significantly, the qbits in FIG. 4 are distributed evenly throughout the lattice so that any qbit can be moved to interact with any other qbit without the need for performing swap gate operations. For example, the bolded interconnection lines indicate the different pathways qbit 434 can be shuttled to reach other qbits in the lattice without the need for swap gate operations.

Note that FIG. 4 is one of many possible arrangements of the qbit lattice. Moreover, while the arrangement in FIG. 4 may be ideal for some quantum algorithms it will not be ideal for other quantum algorithms. Consequently, in one embodiment, the dynamic scheduler 230 tunes the connectivity of areas of the lattice selectively, by scanning the quantum algorithms included in the quantum runtime 202 and detecting and profiling computational patterns to identify the most efficient arrangement of qbits and vacant locations. Based on this information, the adaptive machine configuration controller 240 dynamically initializes a pattern/sequence of chip control voltages to create specific device occupation densities and patterns, by vacating (or filling) quantum dot sites with physical qubits. Once the desired pattern has been established, one embodiment of the dynamic scheduler 230 adjusts the machine code of the quantum runtime 202 in accordance with the reconfigured device topology. As mentioned, this may involve changing one or more swap gate operations to shuttle operations.

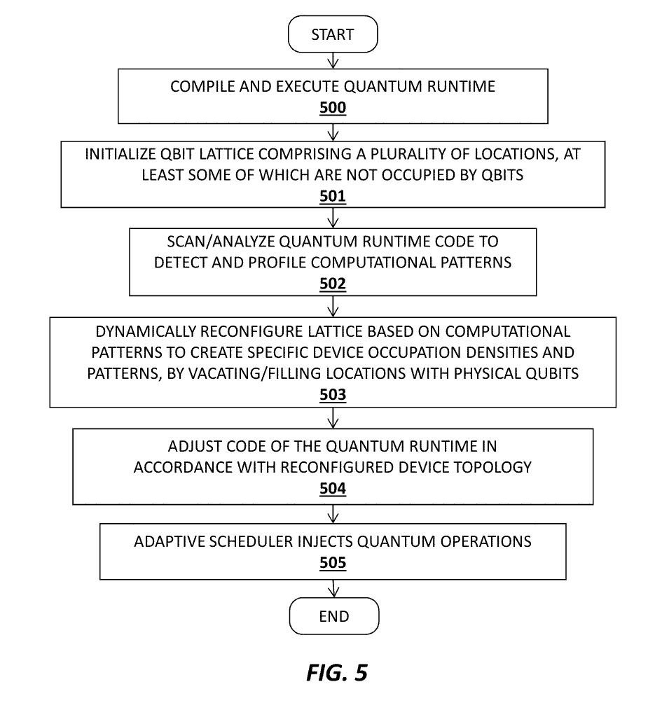

A method in accordance with one embodiment of the invention is illustrated in FIG. 5. The method may be implemented within the context of the system architectures described above, but is not limited to any particular system architecture.

At 500, the quantum runtime is compiled and executed and at 501, a qbit lattice comprising a plurality of locations is initialized so that some locations include qbits and other locations are unoccupied. At 502, the quantum runtime is scanned/analyzed to detect and profile computational patterns. For example, the physical interactions between qbits required to implement a plurality of quantum gates may be identified.

At 503, the interconnection lattice is dynamically reconfigured based on the computational patterns to create specific device occupation densities and patterns by vacating/filling quantum dot locations with physical qbits. At 504, the code of the quantum runtime is adjusted in accordance with the reconfigured device topology. For example, one or more operations may be swapped in place of existing operations within the quantum runtime or the quantum runtime may be supplemented with the new operations. Alternatively, the quantum program code 200 may be dynamically updated and recompiled by the compiler 201 prior to execution.

At 505, the adaptive scheduler injects the modified quantum operations to the qbit lattice. As mentioned, if it results in a more efficient sequence of operations, shuttling of qbits may be performed to physically move the qbits desired locations in the lattice. Once the sequence of operations have been performed, values of data qbits are read and stored in the results 270.

While some embodiments are described above with respect to a quantum dot processor, the underlying principles of the invention are not limited to any particular physical implementation of qbits. The techniques described herein are intended to be used to improve the efficiency of different types of physical devices having different physical characteristics. Consequently, in one embodiment, the dynamic scheduler 230 evaluates the characteristics of the specific quantum processor 260 in use when evaluating the quantum runtime and rendering configuration decisions.

Using the techniques described above provides for physical quantum devices which are significantly more flexible when processing a wide range of algorithmic workloads. Moreover, these techniques reduce circuit depth for executed algorithms, reduce the burden of error correction, increase the probability of algorithm success, and reduce the thermal budgeting burden. Furthermore, error correction schemes can be chosen which selectively take advantage of the different connectivity and physical characteristics of different devices, offering the ability to choose the best error correction option on-the-fly, given different available error correction mechanisms.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

### EXAMPLES

### Example 1

A method comprising: analyzing quantum runtime code to detect quantum computational patterns within the quantum runtime code; dynamically configuring a quantum bit (qbit) lattice based on the detected quantum computational patterns, the qbit lattice comprising a plurality of locations and dynamically configured with some locations occupied by qbits and other locations not occupied by qbits; and modifying at least a portion of the quantum runtime code based on the reconfiguration of the qbit lattice.

### Example 2

The method of Example 1 wherein dynamically reconfiguring comprises shuttling at least one qbit from a first location within the qbit lattice to a second location within the qbit lattice.

### Example 3

The method of Example 2 wherein shuttling comprises moving the qbit from the first location through a plurality of intermediate locations to arrive at the second location.

### Example 4

The method of Example 3 wherein the qbit is moved to the plurality of intermediate locations and the second location without performing a swap gate operation.

### Example 5

The method of Example 1 wherein analyzing comprises identifying physical interactions between qbits specified within the quantum runtime code.

### Example 6

The method of Example 1 wherein analyzing comprises identifying one or more quantum gates implemented by the quantum runtime code.

### Example 7

The method of Example 1 wherein the qbit lattice comprises a quantum dot device.

### Example 8

The method of Example 7 wherein each location in the quantum dot device comprises an electron spin-based quantum dot or a hole spin-based quantum dot.

### Example 9

The method of Example 8 wherein each quantum dot is coupled to one or more other quantum dots over one or more quantum gate lines.

### Example 10

The method of Example 9 wherein dynamically reconfiguring the qbit lattice comprises applying voltages, currents, radio frequency (RF) signals, and/or microwave signals to one or more of the quantum gate lines.

### Example 11

An apparatus comprising: a quantum bit (qbit) lattice comprising a plurality of qbit locations; a quantum controller to execute quantum runtime code; a dynamic scheduler to analyze the quantum runtime code to detect quantum computational patterns within the quantum runtime code; an adaptive machine configuration controller to dynamically configure the qbit lattice based on the detected quantum computational patterns, the qbit lattice dynamically configured with some locations occupied by qbits and other locations not occupied by qbits; and the dynamic scheduler to modify at least a portion of the quantum runtime code based on the reconfiguration of the qbit lattice.

### Example 12

The apparatus of Example 11 wherein, to dynamically configure the qbit lattice, the adaptive machine configuration controller is to shuttle at least one qbit from a first location within the qbit lattice to a second location within the qbit lattice.

### Example 13

The apparatus of Example 12 wherein the adaptive machine configuration controller is to move the qbit from the first location through a plurality of intermediate locations to arrive at the second location.

### Example 14

The apparatus of Example 13 wherein the adaptive machine configuration controller moves the qbit to the plurality of intermediate locations and the second location without performing a swap gate operation.

### Example 15

The apparatus of Example 11 wherein, to analyze the quantum runtime code, the dynamic scheduler is to identify physical interactions between qbits specified within the quantum runtime code.

### Example 16

The apparatus of Example 11 wherein, to analyze the quantum runtime code, the dynamic scheduler is to identify one or more quantum gates implemented by the quantum runtime code.

### Example 17

The apparatus of Example 11 wherein the qbit lattice comprises a quantum dot device.

### Example 18

The apparatus of Example 17 wherein each location in the quantum dot device comprises an electron spin-based quantum dot or a hole spin-based quantum dot.

### Example 19

The apparatus of Example 18 wherein each quantum dot is coupled to one or more other quantum dots over one or more quantum gate lines.

### Example 20

The apparatus of Example 19 wherein dynamically reconfiguring the qbit lattice comprises applying voltages, currents, radio frequency (RF) signals, and/or microwave signals to one or more of the quantum gate lines.

### Example 21

A machine-readable medium having program code stored thereon which, when executed by a machine, causes the machine to perform the operations of: analyzing quantum runtime code to detect quantum computational patterns within the quantum runtime code; dynamically configuring a quantum bit (qbit) lattice based on the detected quantum computational patterns, the qbit lattice comprising a plurality of locations and dynamically configured with some locations occupied by qbits and other locations not occupied by qbits; and modifying at least a portion of the quantum runtime code based on the reconfiguration of the qbit lattice.

### Example 22

The machine-readable medium of Example 21 wherein dynamically reconfiguring comprises shuttling at least one qbit from a first location within the qbit lattice to a second location within the qbit lattice.

### Example 23

The machine-readable medium of Example 22 wherein shuttling comprises moving the qbit from the first location through a plurality of intermediate locations to arrive at the second location.

### Example 24

The machine-readable medium of Example 23 wherein the qbit is moved to the plurality of intermediate locations and the second location without performing a swap gate operation.

### Example 25

The machine-readable medium of Example 21 wherein analyzing comprises identifying physical interactions between qbits specified within the quantum runtime code.

### Example 26

The machine-readable medium of Example 21 wherein analyzing comprises identifying one or more quantum gates implemented by the quantum runtime code.

### Example 27

The machine-readable medium of Example 21 wherein the qbit lattice comprises a quantum dot device.

### Example 28

The machine-readable medium of Example 27 wherein each location in the quantum dot device comprises an electron spin-based quantum dot or a hole spin-based quantum dot.

### Example 29

The machine-readable medium of Example 28 wherein each quantum dot is coupled to one or more other quantum dots over one or more quantum gate lines.

### Example 30

The machine-readable medium of Example 29 wherein dynamically reconfiguring the qbit lattice comprises applying voltages, currents, radio frequency (RF) signals, and/or microwave signals to one or more of the quantum gate lines.

What is claimed is:

1. A method comprising:
analyzing quantum runtime code to detect quantum computational patterns within the quantum runtime code;
dynamically configuring a quantum bit (qbit) lattice based on the detected quantum computational patterns, the qbit lattice comprising a plurality of locations and dynamically configured with some locations occupied by qbits and other locations not occupied by qbits; and
modifying at least a portion of the quantum runtime code based on the reconfiguration of the qbit lattice.

2. The method of claim 1 wherein dynamically reconfiguring comprises shuttling at least one qbit from a first location within the qbit lattice to a second location within the qbit lattice.

3. The method of claim 2 wherein shuttling comprises moving the qbit from the first location through a plurality of intermediate locations to arrive at the second location.

4. The method of claim 3 wherein the qbit is moved to the plurality of intermediate locations and the second location without performing a swap gate operation.

5. The method of claim 1 wherein analyzing comprises identifying physical interactions between qbits specified within the quantum runtime code.

6. The method of claim 1 wherein analyzing comprises identifying one or more quantum gates implemented by the quantum runtime code.

7. The method of claim 1 wherein the qbit lattice comprises a quantum dot device.

8. The method of claim 7 wherein each location in the quantum dot device comprises an electron spin-based quantum dot or a hole spin-based quantum dot.

9. The method of claim 8 wherein each quantum dot is coupled to one or more other quantum dots over one or more quantum gate lines.

10. The method of claim 9 wherein dynamically reconfiguring the qbit lattice comprises applying voltages, currents, radio frequency (RF) signals, and/or microwave signals to one or more of the quantum gate lines.

11. An apparatus comprising:
a quantum bit (qbit) lattice comprising a plurality of qbit locations;
a quantum controller to execute quantum runtime code;
a dynamic scheduler to analyze the quantum runtime code to detect quantum computational patterns within the quantum runtime code;
an adaptive machine configuration controller to dynamically configure the qbit lattice based on the detected quantum computational patterns, the qbit lattice dynamically configured with some locations occupied by qbits and other locations not occupied by qbits; and
the dynamic scheduler to modify at least a portion of the quantum runtime code based on the reconfiguration of the qbit lattice.

12. The apparatus of claim 11 wherein, to dynamically configure the qbit lattice, the adaptive machine configuration controller is to shuttle at least one qbit from a first location within the qbit lattice to a second location within the qbit lattice.

13. The apparatus of claim 12 wherein the adaptive machine configuration controller is to move the qbit from the first location through a plurality of intermediate locations to arrive at the second location.

14. The apparatus of claim 13 wherein the adaptive machine configuration controller moves the qbit to the plurality of intermediate locations and the second location without performing a swap gate operation.

15. The apparatus of claim 11 wherein, to analyze the quantum runtime code, the dynamic scheduler is to identify physical interactions between qbits specified within the quantum runtime code.

16. The apparatus of claim 11 wherein, to analyze the quantum runtime code, the dynamic scheduler is to identify one or more quantum gates implemented by the quantum runtime code.

17. The apparatus of claim 11 wherein the qbit lattice comprises a quantum dot device.

18. The apparatus of claim 17 wherein each location in the quantum dot device comprises an electron spin-based quantum dot or a hole spin-based quantum dot.

19. The apparatus of claim 18 wherein each quantum dot is coupled to one or more other quantum dots over one or more quantum gate lines.

20. The apparatus of claim 19 wherein dynamically reconfiguring the qbit lattice comprises applying voltages, currents, radio frequency (RF) signals, and/or microwave signals to one or more of the quantum gate lines.

21. A machine-readable medium having program code stored thereon which, when executed by a machine, causes the machine to perform the operations of:
analyzing quantum runtime code to detect quantum computational patterns within the quantum runtime code;
dynamically configuring a quantum bit (qbit) lattice based on the detected quantum computational patterns, the qbit lattice comprising a plurality of locations and dynamically configured with some locations occupied by qbits and other locations not occupied by qbits; and
modifying at least a portion of the quantum runtime code based on the reconfiguration of the qbit lattice.

22. The machine-readable medium of claim 21 wherein dynamically reconfiguring comprises shuttling at least one qbit from a first location within the qbit lattice to a second location within the qbit lattice.

23. The machine-readable medium of claim 22 wherein shuttling comprises moving the qbit from the first location through a plurality of intermediate locations to arrive at the second location.

24. The machine-readable medium of claim 23 wherein the qbit is moved to the plurality of intermediate locations and the second location without performing a swap gate operation.

25. The machine-readable medium of claim 21 wherein analyzing comprises identifying physical interactions between qbits specified within the quantum runtime code.

26. The machine-readable medium of claim 21 wherein analyzing comprises identifying one or more quantum gates implemented by the quantum runtime code.

27. The machine-readable medium of claim 21 wherein the qbit lattice comprises a quantum dot device.

28. The machine-readable medium of claim 27 wherein each location in the quantum dot device comprises an electron spin-based quantum dot or a hole spin-based quantum dot.

29. The machine-readable medium of claim 28 wherein each quantum dot is coupled to one or more other quantum dots over one or more quantum gate lines.

30. The machine-readable medium of claim 29 wherein dynamically reconfiguring the qbit lattice comprises applying voltages, currents, radio frequency (RF) signals, and/or microwave signals to one or more of the quantum gate lines.
